(19) United States
(12) Patent Application Publication
(10) Pub. No.: US 2004/0086241 A1
(43) Pub. Date: May 6, 2004

(54) Optical fiber cable and process for manufacture of an optical fiber cable

(76) Inventors: Wolfgang Brunke, Berlin (DE); Drik Gustke, Berlin (DE); Reinhard Koehler, Berlin (DE)

Correspondence Address: CORNING CABLE SYSTEMS LLC, P O BOX 489, HICKORY, NC, 28603, US

(21) Appl. No.: 10/695,671

(22) Filed: Oct. 29, 2003

(30) Foreign Application Priority Data
Oct. 31, 2002 (DE) 10250879.8

(51) Int. Cl. G02B 6/44

(52) U.S. Cl. 385/100

(57) ABSTRACT

For an optical fiber cable with a cable core, which contains at least one optical transmission element, and with a cable jacket surrounding the cable core, a plastic film is applied over the cable core before extrusion of the cable jacket. The plastic film contains a material, which is also contained in the cable jacket. The cable jacket is extruded over the cable core and brought into contact with the plastic film in such a way, that it glues to the cable jacket during extrusion. In this way a cable construction for an optical fiber cable is created, which enables a comparatively small diameter of the cable and a comparatively cost-effective manufacture.

### FIELD OF INVENTION

The present invention concerns an optical fiber cable with a cable core, which has at least one optical transmission element, and a cable jacket surrounding the cable core. Additionally, the present invention concerns a process for the manufacture of such an optical fiber cable.

### BACKGROUND OF THE INVENTION

Optical fiber cables are manufactured in a multitude of cable constructions. When conceiving an optical fiber cable, besides other aspects, it is often the objective to construct the cable with longitudinal water impermeability, perhaps by providing filling compounds or swellable materials, which are contained in the cable core.

In a typical cable construction, several bundle cores are stranded around a central element, which contain one or more optical fibers. The cavities between the bundle core are filled with a filling compound. Over the stranded bundle cores, a swell tape and/or a film wrap of a plastic film is applied. Over these, tension relief elements such as yarns made of glass or aramid are applied. The cable is enclosed by a cable jacket. The longitudinal water impermeability within the cable core is guaranteed by the filling compound, in the cable jacket by swelling of swell tape during water penetration into the cable.

In a further typical cable construction, where no film wrap or swell tape is provided around the cable core, the cavities between the bundle cores are filled with a special pasty filling compound. This special pasty filling compound is known as Füllnidtz filling compound contains small quartz pebbles in an emulsion. The special nature of such a filling compound makes it possible for it to come in contact with the hot plastic jacket material during the extrusion process, without the creation of blisters or jacket damage. This is necessary, since due to eliminating the film wrap or a swell tape, respectively, around the cable core there is no thermal protection of the filling compound during the extrusion of the cable jacket. However, the use of such a filling compound with thermal stability leads generally to an increase in the manufacturing costs for the optical fiber cable.

The use especially of swell tape has generally the disadvantage, that it shows a relatively large thickness of f.e. 0.2 to 0.4 mm. In the described case where a swell tape surrounds the cable core of an optical fiber cable, the cable diameter has to be correspondingly large. A separate wrapping of the cable core with a plastic film also leads to a diameter increase of the optical fiber cable. This is especially disadvantageous, when such an optical fiber cable has to be blown into a comparatively thin tube during the installation process. For such an installation of an optical fiber cable, any kind of decrease in the cable diameter is of advantage. A further disadvantage of the use of swell tape is the comparatively high manufacturing cost.

### ASPECT OF THE INVENTION

It is the objective of the present invention, to create a cable construction of an optical fiber cable, which enables a comparatively small cable diameter and which can be manufactured in a comparatively cost-effective way.

Additionally, it is the objective of the present invention to give a corresponding manufacturing process.

### SUMMARY OF THE INVENTION

For the optical fiber cable according to the invention, a plastic film is provided, which surrounds the cable core and is in contact with the cable jacket. The plastic film has a material, which is also contained in the cable jacket, where the plastic film is further constructed in such a way, that it becomes glued to the cable jacket during the extrusion process. In the process for the manufacture of the optical fiber cable, the plastic film is applied over the cable core before the extrusion of the cable jacket over the cable core. The cable jacket is then extruded over the cable core and brought into contact with the plastic film in such a way, that it is glued to the cable jacket during its extrusion. This eliminates the use of a separate cable core wrap in the cable end product, which would increase the diameter of the cable. Since the plastic film is glued to the cable jacket during extrusion in the optical fiber cable according to the invention, the cable diameter does not increase measurably, since the plastic film practically melts together with the cable jacket.

The provision of a plastic film around the cable core according to the invention fulfills a multitude of objectives, especially during the manufacture of the optical fiber cable. On the one hand, the plastic film can serve as a position fixing for the filling compound present in the cable core; in addition, the plastic film prevents contamination of the stranding line and of the jacket extruder during manufacture of the optical fiber cable, while the cable core runs through several construction lines at which time the cable jacket has not been applied to the cable core. With several optical transmission elements, f.e. in the form of stranded bundle cores, the plastic film serves as a stabilization medium. An important advantage of the plastic film according to the invention is found in the fact, that it serves as thermal protection during cable manufacture, so that the heat generated during the manufacturing process, in which the cable jacket is applied by extrusion, is held away. In this way it is possible to use a comparatively cost-effective standard filling compound.

According to this, in a further development of the invention, an optical fiber cable can be created, where the cable core contains a standard filling compound, which has a drip point below the extrusion temperature of the cable jacket. The use of a film wrap surrounding the cable core, which is separable from the cable jacket in the cable end product, can be eliminated.

### BRIEF DESCRIPTION OF THE DRAWING FIGURES

FIG. 1 is a construction form of an optical fiber cable according to the invention.

FIG. 2 is a construction form of an optical fiber cable according to the state-of-the-art.

FIG. 3 is a further construction form of an optical fiber cable according to the state-of-the-art.

### DETAILED DESCRIPTION OF THE INVENTION

FIG. 2 shows a typical cable construction of an optical fiber cable according to the state-of-the-art. Bundle cores 1 with optical transmission elements in the form of optical fibers 10 as well as blind elements 3 are stranded around a central element 2. The cavities thus created between the central element 2, bundle cores 1 and blind elements 3 are filled with a standard filling compound 4. Standard filling compound means, that the drip point of the filling compound lies below the extrusion temperature of the cable jacket. Standard filling compounds are petrolatum containing high viscosity liquids, which prevent dampness from reaching the bundle cores. A film wrap 5 is applied over the stranded bundle cores 1 and the blind elements 3, over which the tension relief element 6, especially in the form of yarns made of glass or aramid, are applied. The cable is enclosed by a cable jacket 7, which contains polyethylene in the given construction sample. The film wrap 5 can be a swell tape or a film made of plastic in the given construction sample.

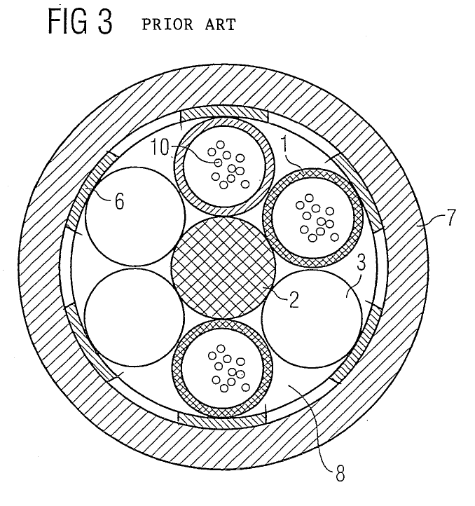

FIG. 3 shows another construction form of an optical fiber cable according to the state-of-the-art. Here the cavities within the cable core between the central element 2, the bundle cores 1 and the blind elements 3 are filled with a special pasty filling compound 8. This special pasty filling compound is also known as Füllnidtz filling compound and contains small quartz pellets within an emulsion. Into this pasty filling compound 8 the tension relief elements 6 can be inserted and afterwards the cable jacket 7 can be extruded over it. The special nature of the pasty filling compound 8 makes it possible, that it comes in direct contact with the hot cable jacket material during the extrusion process without causing blisters or jacket damage. In this way, a film wrap 5 according to FIG. 2 can be eliminated.

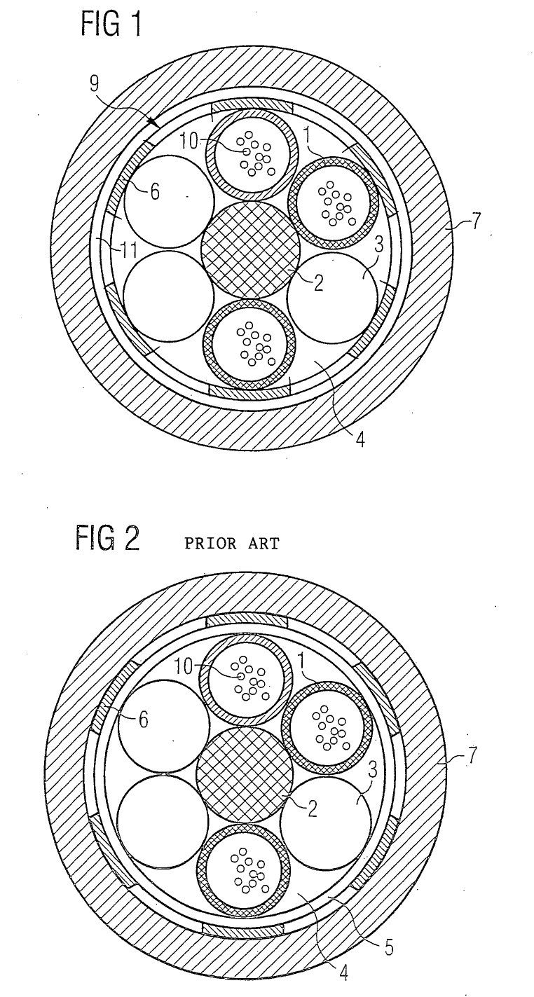

FIG. 1 shows the construction form of an optical fiber cable according to the invention. According to FIGS. 1, 2 bundle cores 1 with optical fibers 10 and blind elements 3 are stranded around a central element 2. The cavities in the interior of the cable core 9 between the central element, bundle cores and blind elements are filled with standard filling compound 4, which has a drip point below the extrusion temperature of the cable jacket 7. Over the stranded bundle cores 1 and the blind elements 3, tension relief elements 6, especially yarns made of glass or aramid, are located. The cable core 9 is surrounded by a plastic film 11, which is in contact with the cable jacket 7. The cable jacket 7 as well as the plastic film 11 show a similar base material, especially polyethylene, polypropylene or polyvinyl chloride. The plastic film 11 is applied over the cable core 9 before extrusion of the cable jacket 7, where the plastic film 11 comes in contact with the hot cable jacket material during the extrusion process. The plastic film 11 begins to glue to the cable jacket 7 and normally cannot be differentiated from the cable jacket 7 after manufacture of the optical fiber cable.

The plastic film 11 serves as thermal protection, by holding away the heat being generated from the construction elements of the optical fiber cable beneath it. This prevents, that blind elements 3 are fused, which can lead to problems during cable installation. It also avoids the filling compound becoming overheated and forming blisters, which can lead to bursting of the cable jacket during manufacturing. In comparison to the optical fiber cable in FIG. 2, a film wrap surrounding the cable core, which can be separated in the end product, can be eliminated. This makes it possible, to produce the optical fiber cable according to the invention with a comparatively smaller diameter. Against the optical fiber cable according to FIG. 3, the optical fiber cable according to the invention has the advantage, that an expensive, temperature stable filling compound for the cable core can be eliminated and instead a more cost-effective standard filling compound can be used. Another advantage lies in the fact, that gluing together of cable jacket and blind elements is avoided.

The invention thus provides a cable construction for an optical fiber cable with longitudinal water impermeability, which can be produced in a comparatively cost-effective way with standard filling compounds. At the same time, a cable core wrap, which is separate from the cable jacket in the end product, can be eliminated, which is an advantage for cable construction, where such a separate cable wrap is not desired.

Accordingly, what is claimed is:

1. Optical fiber cable with a cable core, which shows at least one optical transmission element, with a cable jacket surrounding the cable core and with a plastic film surrounding the cable core, which is in contact with the cable jacket and which shows a material, which is also contained in the cable jacket, which glues it to the cable jacket during extrusion of the cable jacket.

2. Optical fiber cable according to claim 1, wherein the cable jacket and the plastic film containing at least one common material from a group having polyethylene, polypropylene or polyvinyl chloride.

3. Optical fiber cable according to claim 1, wherein the cable core containing a filling compound, which has a drip point below the extrusion temperature of the cable jacket, and the optical fiber cable not showing any film or swell tape wraps, which can be separated from the cable jacket.

4. Process for the manufacture of an optical fiber cable with a cable core, which contains at least one optical transmission element, and with a cable jacket surrounding the cable core, where a plastic film is applied to the cable core before the extrusion of the cable jacket, where the plastic film contains a material, which is also contained in the cable jacket, and where the cable jacket is extruded over the cable core and brought into contact with the plastic film in such a way, that it glues to the cable jacket during its extrusion.

5. Process according to claim 4, wherein the cable core being filled before extrusion of the cable jacket with a filling compound, which has a drip point below the extrusion temperature of the cable jacket.
